(19) United States
(12) Patent Application Publication
(10) Pub. No.: US 2015/0212809 A1
(43) Pub. Date: Jul. 30, 2015

(54) Method for the Usage-Controlled Updating of a Software Product

(71) Applicant: HEIDELBERGER DRUCKMASCHINEN AG, HEIDELBERG (DE)

(72) Inventor: EBERHARD REDMER, ASCHEBERG (DE)

(21) Appl. No.: 14/607,480

(22) Filed: Jan. 28, 2015

(30) Foreign Application Priority Data
Jan. 28, 2014 (DE) 102014001108.9

(51) Int. Cl. G06F 9/445; G06F 9/44

(52) U.S. Cl. CPC G06F 8/65; G06F 8/68

(57) ABSTRACT

A method for the usage-controlled updating of a software product for a machine using a computer, includes collecting key operating figures on the usage of the software product in the form of a customer-specific data record by using the computer, saving the data records on the computer, determining the components of the software product that require an update by evaluating the data record, and implementing the determined updates on the computer.

### CROSS-REFERENCE TO RELATED APPLICATION

This application claims the priority, under 35 U.S.C. §119, of German Patent Application DE 10 2014 001 108.9, filed Jan. 28, 2014; the prior application is herewith incorporated by reference in its entirety.

### BACKGROUND OF THE INVENTION

### Field of the Invention

The present invention relates to a method for the usage-controlled updating of a software product for a machine using a computer.

The technical field of the invention is the development of application software.

Several types of updates are known in the prior art. On one hand, users may make manual updates by actively installing a new version of the software themselves. On the other hand, above all there are automated updates that are made without any user intervention. In addition, there are hybrid types of updates that include an automated updating process but prompt the user to decide whether or not an update is to be installed and which parts of an update are to be installed.

Automated updates vary in terms of the way in which the required data are transmitted and in terms of the decision as to whether or not an update is necessary. The most common methods rely on the version number of the software to decide whether or not an update is necessary. As far as the process of transmitting the data is concerned, there are several options: for example, the update package may be downloaded by hand or in an automated way from a server, or an active server may scan a number of clients that run the target software in question and may update them accordingly. For automated updates, the data are always transmitted through a network, which may be a wired network such as a LAN or a bus system or a wireless network such as a mobile radio communication system or WLAN. The network may be a network within a company (Intranet). Alternatively, the update packages may be transmitted directly through the Internet if the software to be updated has web access.

German Patent Application DE 103 46 478 A1, corresponding to International Publication WO 2005/033934, for example, discloses a system and method for a flexible software update for automation systems through the Internet. The automation system includes a special software component which is provided for collecting and transmitting information on the automation system in standardized form, e.g. as an SML file. The software component determines the current software and/or hardware configuration of the automation system, i.e. on the computer of the automation system. The standardized way of collecting or preparing information enables integration in various processes, e.g. for a structured error management, and automatic detection allows the burden on the service departments to be relieved. The information on the automation system collected by the software component is, in particular, used to bring the current software configuration of a product into line with recommended updates.

The disadvantage of the prior art is that a decision on the necessity of an update based on the version number of the software generates a massive flow of useless data. In many cases, an update is made although it is irrelevant for a particular user, for example because the update refers to software parts that the user does not use or because the update corrects errors that do not affect the user. In addition, the implementation of necessary updates may be compromised, especially if the associated network only has low data transmission rates. Moreover, frequent unnecessary updates result in a limited availability because in most cases, the software may not be used while it is being updated. That may result in considerable loss if the software was in use and production processes are still pending.

### SUMMARY OF THE INVENTION

It is accordingly an object of the invention to provide a method of updating software, which overcomes the hereinafore-mentioned disadvantages of the heretofore-known methods of this general type and which is based on the usage of the software by the user as the decisive factor for determining the necessity of an update.

With the foregoing and other objects in view there is provided, in accordance with the invention, a method for the usage-based updating of a software product for a machine using a computer, which comprises the steps of:
1. Collecting key operating figures on the usage of the software product in the form of a customer-specific data record by using the computer;
2. Saving the data record on the computer;
3. Determining the components of the software product that need an update by evaluating the data record; and
4. Implementing the determined updates on the computer.

The main feature is that preferably only those components of the software product that are actually used by the user are updated. Thus, an advantage of the method is that the number of updates of the software product may be reduced to a necessary minimum, in particular minimizing the amount of time in which the software may not be productively used. This is achieved in that the components of the software product collect data, in the following referred to as key operating figures, on their usage. These data may include the number of accesses during an operating cycle, the time of use or the duration of use, for example. The key operating figures are saved in a data record on the computer that runs the software product and may be evaluated by the computer. Based on the evaluation, a specific usage profile will be established. The specific usage profile will be used to develop an individual installation strategy tailored to the requirements of the software user. This means that once all update packages available for the software product have been transmitted to the user, the installation strategy is used to determine which update package will be the first to be installed as the most preferential update.

In accordance with a preferred further development of the method of the invention, the saved data record is forwarded to a server, where it is saved in a user information database. The evaluation of the data record is carried out on the server. This transmission of usage data to a central server allows an extensive analysis of the usage data that goes far beyond a mere installation strategy established on a local computer. Thus, the transmission of the data to the server is the recommended strategy. Some options will be given below.

In accordance with a preferred further development of the method of the invention, the user information database with the usage information may be used for error analysis purposes with a view to remote servicing. If the usage data are available on a centrally accessible server—depending on their being up to date—they may be used to monitor the status of the software product. Thus, remote servicing becomes possible if the user wishes. Since experience shows that most problems in the software field occur due to a misconfiguration, such problems might be solved remotely, i.e. a misconfiguration might be avoided. As a consequence, unnecessary service trips caused by misuse could be avoided.

In accordance with a preferred further development of the method of the invention, based on the evaluation of the data record, an optimum time for the update is defined and the update is carried out at the established optimum time.

In accordance with a preferred further development of the method of the invention, the update is preferably carried out at a time when non-operation of the software product is the least costly. Since it is desirable for the controlled machinery to work to the fullest possible capacity and since the machinery may not be used during an update of the software product that controls the machinery at least indirectly, it is expedient for the update to be carried out during slow times. This may contribute to reducing the downtime cost of the machine during an update. This is clearly not the case when the update corrects an error that has an immediate impact on the output of the machine. Weighing the use of a software product against potential follow-up costs caused by a defective software product allows an optimum compromise to be found between an updated software product and low downtime costs. Thus, an evaluation of the usage data is the basis for determining an optimum time for an update.

In accordance with a preferred further development of the method of the invention, a priority list is created on the basis of the evaluated user information database. The priority list prioritizes the components of the software product that are to be given preference in an updating process. Due to this priority list, the components that are most important for a specific user are updated first. Which components these are depends on the machinery that is controlled by the software product and the individual requirements of the user.

In accordance with a preferred further development of the method of the invention, the software product contains multiple license options, at least one of which needs to be activated for the user. The use of license options allows the functionalities of the software package to be configured in accordance with the individual requirements of the user based on the user information collected in the form of the key operating figures.

In accordance with a preferred further development of the method of the invention, the key operating figures contain information on the usage of the license options such as the proportions of accesses during an operating cycle and the time or duration of use. This information allows the definition of an optimum updating time or the creation of a priority list, for example.

In accordance with a preferred further development of the method of the invention, the key operating figures are written into the database by the activated license options during operation of the software product. Only the activated license options may contribute key operating figures on usage. The key operating figures of activated but unused license options merely include status data and the information on non-use.

In accordance with a preferred further development of the method of the invention, the decision on which components of the software will receive an update is either made automatically or locally in the software product by the users themselves. In order to increase user-friendliness, it may be made possible for the users to configure their own installation strategy in addition to the option of user-specific updating as proposed by the present invention. One possible example is the acceptance of all available updates by default.

In accordance with a preferred further development of the method of the invention, the computer program product is run and serviced on external computers, is operated by a local user through a network, and controls the local machinery and devices through that network. This means that it is possible for the software product to be installed, operated and serviced as system software on a server by the manufacturer. The actual users may operate the software product using a graphical user interface that is connected to the software product remotely through a secure network connection. The local machinery at the user's site is likewise controlled through the secure network connection.

Other features which are considered as characteristic for the invention are set forth in the appended claims.

Although the invention is illustrated and described herein as embodied in a method for the usage-controlled updating of a software product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow chart illustrating the basic principle of how to obtain key operating figures from the software product;

FIG. 2 is a flow chart illustrating the process of recording the key operating figures in the software product;

FIG. 3 is a flow chart illustrating the process of recording user data in the software product;

FIG. 4 is a flow chart illustrating an example of a software update; and

FIG. 5 is a flow chart illustrating the collection of key operating figures and the execution of the update process.

### DETAILED DESCRIPTION OF THE INVENTION

Referring now in detail to the figures of the drawings, with which the method and further functionally advantageous developments thereof will be explained in more detail based on at least one exemplary embodiment and in which corresponding elements are indicated by identical reference symbols, there is seen a software product 4, which will be referred to as a layout program 3, that is installed as a monolithic computer program on a customer's computer 21. So-called license options 5 are important for using the layout program 3. The license options determine the functional spectrum of the layout program 3 and need to be activated by the user by purchased licenses. Examples of such options are a sheet optimizer 6, a bar code generator 7, or a gang assistant 8.

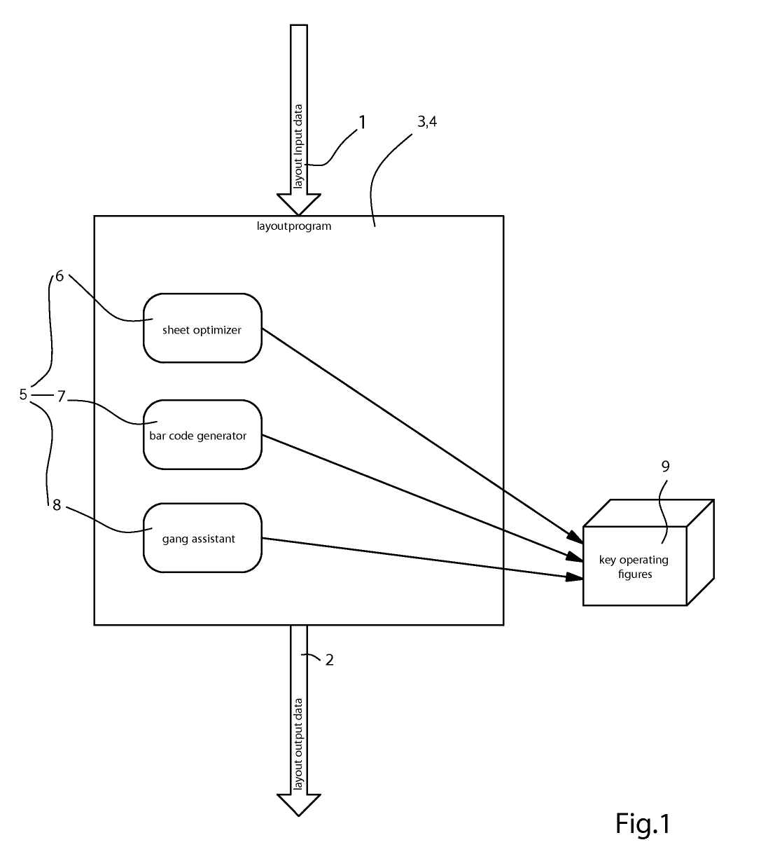

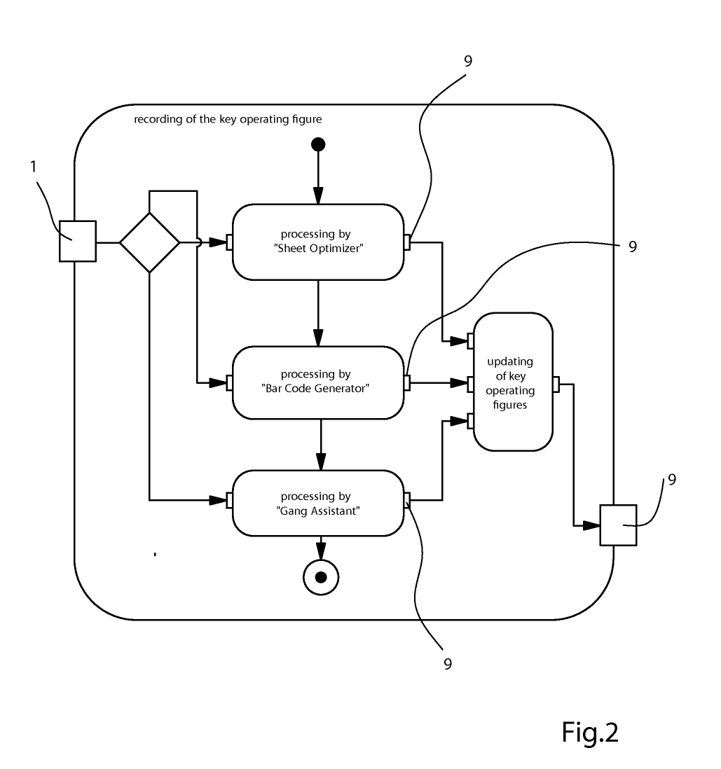

As is shown in FIG. 1, during operation, for each operating process, requests from layout input data 1 and operations of the layout program 3 are used to decide which of the license options 5 are used to generate desired layout output data 2. The license options 5 contained in the layout program 3, i.e. the sheet optimizer 6, the barcode generator 7, and/or the gang assistant 8 record key operating FIGS. 9. The key FIGS. 9 are, for instance, the number of accesses during an operating process, the time of use and the duration of use. The process of recording the key operating FIGS. 9 is illustrated in FIG. 2. Only activated and actively used license options 5 contribute to the recording of data.

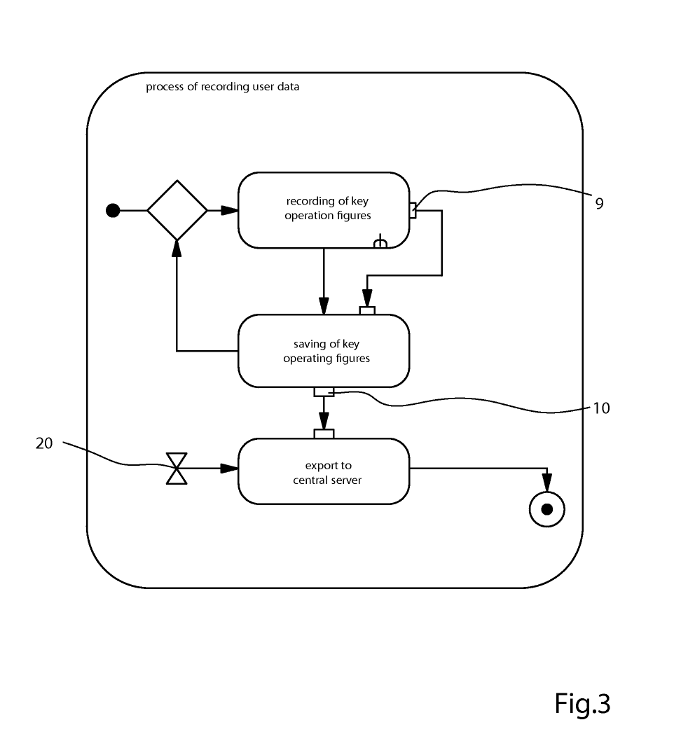

As is shown in FIG. 3, the key operating FIGS. 9 are collected (a step of “recording of key operating figures” corresponds to the process shown in FIG. 2) to form customer-specific usage data 10. These data are continuously forwarded to a server 16 at specific intervals 20. The server 16 is administrated by the supplier of the layout program 3. The data are saved in a user information database 11 on the server 16. The data are then used to derive customer-specific installation strategies 10, for instance in the form of a priority list 15 for possible update packages. This means that components that are not used do not require an immediate update even when critical errors are to be eliminated. In addition, the actual usage information 10, in particular information on the period of use, may be used to define an optimum period of time for an automated update. Thus, an updating of the layout program 3 without interference or with minimum interference with production becomes possible.

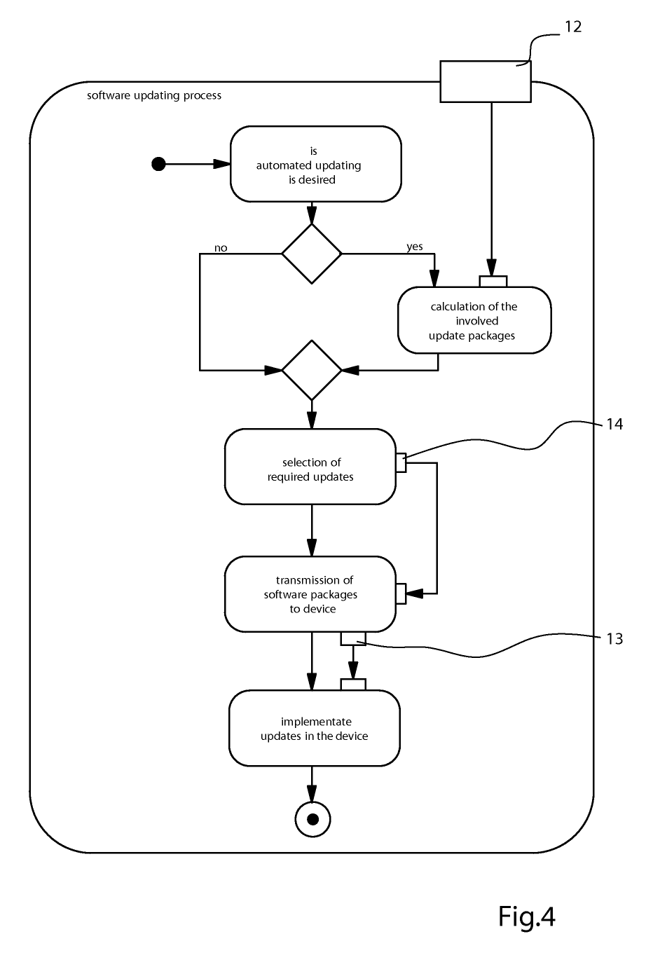

A basic updating process is shown in FIG. 4. The first step is to determine whether or not the user desires automatic updating. The alternatives would be a comprehensive update applying all available update packages 13 or the use of a priority list 15 that has been locally prepared by the user. The query may be made in the form of a configuration or as a direct query to the user by using a graphical user interface 19. When automated updating is desired, an installation strategy 12 that was previously sent to the user together with the update packages by the supplier of the layout program 3 is used to define the update packages 13 required for the update. These packages 13 are then selected and the layout program 3 in question is updated accordingly.

The recorded usage data 10 may furthermore be used to analyze the customer's processes. This means that an analysis may be made to find out whether the user actually needs all of the license options 5 that have been installed or whether the user needs further license options that have not been installed yet to optimize his or her business.

In addition, the usage data 10 may be used for error analysis and remote service purposes at the user's site. Misconfigurations, in particular, are frequently a main source of errors in the use of software products. In many cases, a remote analysis of the configuration is sufficient to identify any errors that have occurred. This may contribute to a massive reduction of required service dispatches. Many other errors may also be remotely diagnosed, for example by evaluating status information of the machine controlled by the layout program 3.

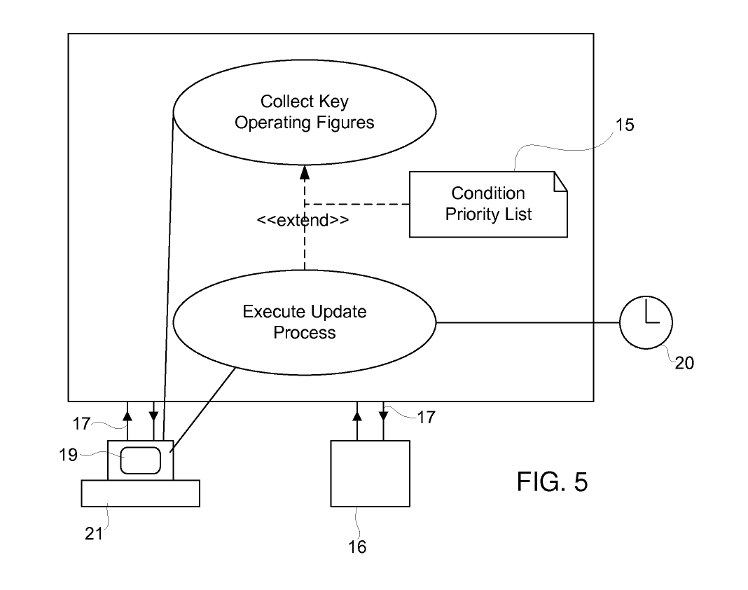

FIG. 5 illustrates the collection of key operating figures and the execution of the update process. The key operating figures are collected from the graphical user interface 19 on the customer's computer 21, which is connected by input and output lines 17, as is the server 16. The collection of the key operating figures leads to the execution of the update process at the specific intervals 20 based on the condition priority list 15.

1. A method for the usage-controlled updating of a software product for a machine using a computer, the method comprising the following steps:
collecting key operating figures on usage of the software product in the form of a customer-specific data record by using the computer;
saving the data record on the computer;
determining components of the software product requiring an update by evaluating the data record; and
implementing the determined updates on the computer.

2. The method according to claim 1, which further comprises transmitting the saved data record to a server, saving the transmitted data record in a database, and carrying out the step of evaluating the data record on the server.

3. The method according to claim 2, which further comprises using the database containing the usage information for error analysis by remote servicing.

4. The method according to claim 1, which further comprises defining an optimum time for an update by evaluating the data record.

5. The method according to claim 4, which further comprises carrying out the updates at the optimum time.

6. The method according to claim 4, which further comprises carrying out the update at times when non-operation of the software product is least costly.

7. The method according to claim 1, which further comprises creating a priority list based on the evaluated data record to define which components of the software product are to be given preference in the updating step.

8. The method according to claim 1, which further comprises providing the software product with multiple license options, at least one of which needs to be activated by the user.

9. The method according to claim 8, which further comprises providing the key operating figures with information on the usage of the license options.

10. The method according to claim 9, wherein the information on the usage of the license options includes a number of accesses during an operating cycle, a time of use or a duration of use.

11. The method according to claim 8, which further comprises writing the key operating figures into the data record by activated license options during operation of the software product.

12. The method according to claim 1, which further comprises deciding which components of the software product receive an update either automatically or locally in the software product by users themselves.
